(19) United States
(12) Patent Application Publication
(10) Pub. No.: US 2009/0136641 A1
(43) Pub. Date: May 28, 2009

(54) Method of fractionating gliadin from wheat gluten protein and fabrication of edible film therefrom

(76) Inventors: Mahmood Azam, Karachi (PK); Abdid Hasnain, Karachi (PK); Muhammad Danish, Karachi (PK); Sohail Akhtar, Karachi (PK)

Correspondence Address: NATH & ASSOCIATES PLLC, 112 South West Street, Alexandria, VA, 22314, US

(21) Appl. No.: 12/230,383

(22) Filed: Aug. 28, 2008

(30) Foreign Application Priority Data
Nov. 27, 2007 (PK) 1370/2007

(51) Int. Cl. A23P 1/08; A23P 1/10

(52) U.S. Cl. 426/515

(57) ABSTRACT

A method for the development of biodegradable or edible film from wheat gluten protein has been revealed. For this purpose, a fraction of gliadin protein, on the basis of solubility, is recovered from ethanolic extract of wheat gluten protein to fabricate homogenous, transparent, heat sealable and water soluble edible films with novel functional and mechanical properties. To reduce film brittleness, glycerol was added in the formulation as a plasticizer. A three dimensional network of gliadin protein's fraction, water and plasticizer is formed by virtue of new hydrogen bonds, hydrophobic interactions and disulphide bonds when such films are produced by casting technique followed by drying. This network provides resistance to moisture, lipid and gas permeation together with glossy sheen when coated on a variety of substrates.

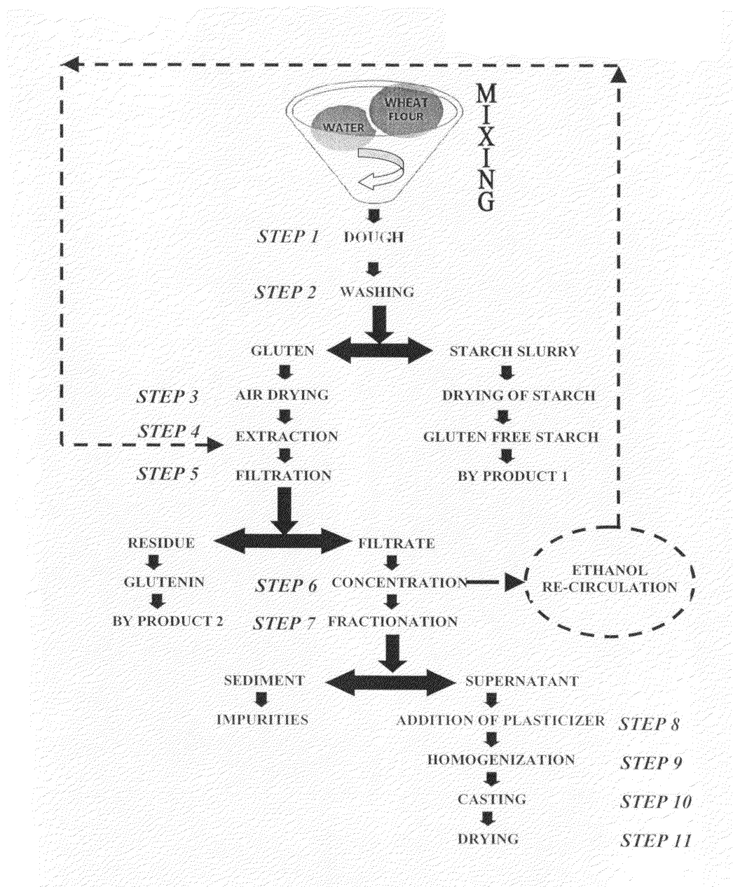

### INTRODUCTION

The use of edible films seems new, but food products were first covered by edible films and coatings many years ago. For example, wax has been used to delay dehydration of citrus fruis in China since the twelfth and thirteen centuries; see [Guibert, S., and Biquet, B., 1986. Technology and Application of Edible Protective Film, Food Packaging and Preservation, Mathlouthi, M., Ed., Elsevier Applied Science Publishers, London, U.K., 371]. The aforementioned review; see [Wu, Y., Weller, C. L., Hamouz, F., Cuppett, S. L., Schnepf, M. 2002. Development and Application of Multi-component Edible Coatings & Films, Advances in Food and Nutritional Research, 44: 348-394] has exemplified the increased interest in the development of edible films and coatings as a result of increased consumer demand for high quality, long shelf-life and ready-to-eat foods and environmental consciousness for disposal of non-renewable food packaging materials; and the opportunities for creating new market outlets for both traditional and novel agricultural crops as the sources of the desired film-forming ingredients. See also [McHugh, T. H., and Krochta, J. M., 1994 a. Milk Protein-based Edible Film and Coatings, Food Technol., 48 (1), 97-103; Guilbert, S., Gontard, N., and Gorris, L. G. M., 1996. Prolongation of the shelf-life of Perishable Food Products using Biodegradable Films & Coatings, Lebensm.-Wiss. U-Technol. 29, 10-17; Gennadios, A., Hamma, M. A., and Kurth, L. B., 1997a. Application of Edible Coating on Meats, Poultry and Seafood: A review. Lebensm-Wiss. U-Technol. 30, 337-350].

Usually coatings are directly applied and formed on the surface of the products, while films are deposed as a continuous layer between food components or formed separately as thin sheets and then applied on the products; see [Gennadious, A., and Weller, C. L., 1990. Edible Films and Coatings from Wheat and Corn Proteins. Food Technol. 44(10), 63-69]. Edible films and coatings are natural polymers obtained from agricultural productions such as animal and vegetable proteins, gums, and lipids.

These proteins include corn zein, wheat gluten, soy protein, peanut protein, keratin, collagen, gelatin and milk proteins including casein and whey proteins. Protein films in particular have been discussed in detail; see [Gennadious, A., McHugh, T. H., Weller, C. L., & Krochta, J. M., 1994 b. Edible Coating and Films based on Proteins, Ch. 9 in ‘Edible Coating and Films to Improve Food Quality’ (M. Krochta, E. A. Baldwin and M. Nisperos-Carrieddo, eds), 201-277. Technomic Publishing Co., Inc., Lancaster, Basel].

Gluten is the main storage protein of wheat recovered as a cohesive and elastic mass left after starch is washed away from wheat flour dough. Wheat gluten is unique among cereals and other plant proteins in its ability to form a cohesive blend with viscoelastic properties once plasticized. The gluten protein can be subdivided in to two approximately equal groups based on their extractability (gliadin) and inextricability (glutenin) in aqueous alcohols; see [Singh, H. and MacRitchie, F., 2001. Application of Polymer Science to Properties of Gluten, Journal of Cereal Science, 33(3): 231-243 and Martin, W. M., 1931. Electro kinetic Properties of Proteins. I. Iso electric Point and Solubility of Wheat Proteins in Aqueous Solutions of Ethanol, Journal of Physical Chemistry, 35: 2065-90].

Gliadins are monomeric proteins with intra-molecular disulphide bonds of low or medium molecular weight. The gliadins are classified in to 4 groups, α, β, γ and ω gliadin, based on electrophroresis mobility under acidic conditions and increasing order of relative molecular mass; see [Jones, R. W., Taylor, N. W. and Senti, F. R., 1959. Electrophoresis and Fractionation of Wheat Gluten, Archives of Biochemistry and Biophysics, 84(2): 363-376]. Although cystine residues are absent in ω gliadin, so-called sulphur poor gliadin, they are involved in intramolecular disulphide bonds in α, β and γ-gliadin; see [Hernandez-Munoz, P., Villalobos, R., and Chiralt, A., 2004. Effect of Thermal Treatments on Functional Properties of Edible Films made from Wheat Gluten Fractions, Food Hydrocolloids, 18 (4), 647-654]. Gliadin show a maximum solubility in solutions containing from fifty to seventy percent of alcohol volume; see [Martin, W. M., 1931. Electro kinetic Properties of Proteins. I. Iso electric Point and Solubility of Wheat Proteins in Aqueous Solutions of Ethanol. Journal of Physical Chemistry, 35: 2065-90].

The ethanolic extract of wheat gluten proteins can be utilized to make homogenous and transparent films with novel functional properties, such as selective gas barrier properties and rubber-like mechanical properties; see [Gennadios, A., 1993. Effect of pH on Properties of Wheat Gluten and Soy Protein Isolate Films, Journal of Agricultural and Food Chemistry, 41: 1835-1839; Gallstedt, M. 2004. Films and Composites Based on Chitosan, Wheat Gluten or Whey Proteins-Their packaging Related Mech. & Barrier Properties, Technical Royal School, KTH: Stockholm; Kayserilioglu, B. S., et al., 2003. Mechanical and Biochemical Characterization of Wheat Gluten Films as a Function of pH and Co-solvent. Starch/Stärke, 53: 381-386; Guilbert, S. 2002. Formation and Properties of Wheat Gluten Films and Coatings, in Protein based Films and Coatings, A. Gennadios, Editor; Anker, C. A., Froster, G. A., and Loader, M. A., 1972. Method of Preparing Gluten Containing Film and Coatings, U.S. Pat. No. 3,653,925; Herald, T. J., et al. 1995. Degradable Wheat Gluten Films: Preparation, Properties and Applications, Journal of Food Science, 60(5): 1147-50].

The formation and property evaluation of wheat gluten films has been dealt with in several studies. In all these studies, films were produced by drying cast aqueous ethanol solutions of wheat gluten.; see [Wall, J. S., and Beckwith, A. C. 1969. Relationship between Structure and Rheological Properties of Gluten Proteins. Cereal Sci. Today, 14:16; Okamoto, S., 1978. Factors Affecting Protein Film Formation. Cereal Food World, 23:256; Gontard, N., Guilbert, S., and Cuq, J. L. 1992. Edible Wheat Gluten Film: Influence of the Main Process Variables on Film Properties using Response Surface Methodology. J. Food Sci. 57:190; Gontard, N., Guilbert, S., and Cuq, J. L., 1993. Water and Glycerol as Plasticizer effect on Mechanical and Water Vapor Barrier Properties of an Edible Wheat Gluten Film. J. Food Sci. 58:190; Gennadios, A., Park, H. J., and Weller, C. L. 1993a. Relative Humidity and Temperature Effect on Tensile Strength of Edible Protein and Cellulose Ether Films, Trans. ASAE 36:1867; Gennadios, A., Weller, C. L. and Testin, R. F. 1993b. Temperature Effect on Oxygen Permeability of Edible Protein-Films. J. Food Science 58:212; Gennadios, A., Weller, C. L. and Testin, R. F. 1993c. Modification of Properties of Edible Wheat Gluten based Film Trans. ASAE 36:465; Gennadios, A., Weller, C. L. and Testin, R. F. 1993d. Modification of Physical and Barrier Properties of Edible Wheat Gluten based Film. Cereal Chem., 70:426].

Drying conditions i.e. temperature and humidity can affect protein conformation and improves some film forming properties; see [Kayserilioglu, B. S., et al., 2003. Mechanical and Biochemical Characterization of Wheat Gluten Films as a Function of pH and Co-solvent. Starch/Stärke, 53: 381-386]. Drying at high temperature can denature gliadin protein leading to exposing of previously unexposed intramolecular disulphide bonds which can form new intermolecular disulphide bonds. As drying progresses, subsequent solvent removal increases the concentration of gluten proteins thereby providing opportunity to active sites to become free to create new interactions. New hydrogen bonds, hydrophobic interactions and disulphide bonds contribute to formation of a good oxygen barrier three-dimensional network; see [Gennadious, A., and Weller, C. L., 1990. Edible Films and Coatings from Wheat and Corn Proteins. Food Technol. 44(10), 63-69; Gennadios, A. 2002. Protein-based Films and Coating, Ed. A. Gennadios, CRC Press LLC, USA & Guilbert, S. 2002. Formation and Properties of Wheat Gluten Films and Coatings, in Protein based Films and Coatings, A. Gennadios, Editor].

As per review; see [Cuq, B., Gontard, N., and Guilbert, S., 1998. Protein as Agricultural polymers for Packaging Production, Cereal Cehm., 75 (1): 1-9], fabrication of edible films requires addition of a suitable plasticizer. With the exception of water, the most usual plasticizers are polyols and mon-, di-, and oligo-saccharides. Plasticizers decrease the brittleness of the protein derived edible films by decreasing attractive intermolecular forces and increasing free volume and chain mobility. As a result of these changes in molecular organization, plasticizer modifies the functional properties of edible films as evident by increase in extensibility and flexibility or a decrease in cohesion, elasticity, rigidity and mechanical resistance. See also [Bakker, M., 1986. Wiley Encyclopedia of Packaging Technology, Jon Wiley and Sons, New York; Banker, G. S., 1966. Film Coating Theory and Practice, J. Pharm. Sci. 55: 81-89; Lieberman, E. R., and Gilbert, S. G., 1973. Gas Permation of Collagen Film as affected by Cross-linking, Moisture, and Plasticizer, J. Polym. Sci. 41: 33.43; McHugh, T. H., and Krochta, J. M., 1994. Sorbitol vs Glycerol plasticized Whey Protein edible Films: Integrated Oxygen Permeability and Tensile Property evaluation, J. Agric. Food Chem., 42: 841-845; Park, H. J., Bunn, J. M., Weller, C. L., Vergano, P. J., and Testin, R. F., 1994. Water vapor Permeability and Mechanical Properties of Grain Protein-Based Film as affected by Mixtures of Polyethylene Glycol and Glycerine Plasticizers, Trans. ASAE 37: 1281-1285; Cuq, B., Gontard, N., Cuq, J. L., and Guilbert, S., 1997b. Selected Functional properties of Myofibrillar Protein-based Films as affected by Hydrophilic Plasticizer, J. Agric. Food Chem., 45: 622-626; Gennadios, A., Weller, C. L., and Testin, R. F., 1993d. Property Modification of Edible Wheat Gluten Based Films. Trans ASAE 36: 465-470; Gontard, N., Guilbert, S., and Cuq, J. L., 1993. Water and Glycerol as Plasticizers affect Mechanical and Water vapor Barrier Properties of an Edible Wheat Gluten Film, J. Food Sci., 58: 206-211].

### BACKGROUND OF THE INVENTION

1. Field of the Invention

This invention relates to the process of making water-soluble edible film which can be used as a sealing and packaging material for a range of processed and un-processed foods where intervening moisture, lipid & gas permeability and resultant glossy sheen extends the shelf-life and quality of the food respectively.

2. Description of the Prior Art

Considering commercial viability and abundant availability, a number of plant proteins have been used for producing edible films and coatings; see [Gennadious, A., McHugh, T. H., Weller, C. L., & Krochta, J. M., 1994 b. Edible Coating and Films based on Proteins. Ch. 9 in ‘Edible Coating and Films to Improve Food Quality’, (M. Krochta, E. A. Baldwin and M. Nisperos-Carrieddo, eds), 201-277, Technomic Publishing Co., Inc., Lancaster Basel]. Particularly, proteins derived from wheat gluten have been explored by the researchers to form edible or biodegradable films with appropriate plasticizers. Moreover, in view of comparison to other biomaterials and many synthetic polymers, wheat gluten proteins are inexpensive to fabricate flexible films. Therefore, efforts have been made to optimize their thermal and mechanical properties together with permeability while increasing their clarity and gloss.

Gluten derived edible films are traditionally obtained by casting in a thin layer and then drying of aqueous alcoholic protein solution in acidic or basic conditions; see review [Cuq, B., Gontard, N., & Guilbert, S., 1998, Proteins as Agricultural Polymers for Packaging Production, Cereal Chem., 75 (1), 1-9]. The use of organic solvent, ethanol, poses safety issues with the emission of vapors during the drying or curing of film which may lead to fire hazard while extreme pH values are often incompatible with the food. These two disadvantages create hesitation and reluctance from the food industry and restrict the application of gluten derived edible films and coatings. Much of the prior work addressed these two disadvantages by focusing on the method of making gluten derived aqueous colloidal dispersion while avoiding use of large quantities of organic solvent, ethanol, as a part of film casting solutions or dispersions.

The prior art see [Bassi et. al., U.S. Pat. No. 5,977,312, Nov. 2, 1999] has described a method of producing gluten derived edible films by using aqueous, essentially ethanol-free casting dispersion. In this method, wheat gluten is modified via reducing agent for cleaving of disulfide bonds under controlled conditions. Such modified wheat gluten can be used to fabricate edible films having superior physical properties while avoiding use of large quantities of ethanol as a part of film casting solutions or dispersions. On the other hand the prior art see [Shulman et. al., U.S. Pat. No. 6,174,559, Jan. 16, 2001; Shulman et. al., U.S. Pat. No. 6,197,353, Mar. 6, 2001] also eliminated the use of organic solvent, ethanol, as a casting or dispersion solution by disclosing a method of making gluten derived aqueous colloidal dispersion. In this method, protease and diastase enzymes were used to hydrolyze protein and starch under controlled conditions to produce an aqueous colloidal dispersion which upon application to a substrate imparts a gloss thereon. Similarly, the prior art see [Cook et. al., U.S. Pat. No. 5,705,207, Jan. 6, 1998] presented another approach of partial hydrolysis of starch only to obtain gluten micro-particles in an aqueous colloidal dispersion that can impart a glossy coating on a substrate.

Nevertheless, water has a much higher boiling point than ethanol. It hampers the drying or curing of films i.e. gluten derived aqueous colloidal dispersion. Even at elevated temperature, the time of drying or curing is much longer than the gluten derived ethanol dispersion and hence increases the cost of fabrication. Similarly, drying or curing of film at high temperature also restricts the application of gluten derived aqueous colloidal dispersion on the fresh horticultural produces as they are more vulnerable to deteriorate when heated outside their physiological ranges. High temperature also causes heat denaturation of gluten proteins which in turn lowers the ultimate strength of gluten derived edible films. Similarly, modification of gluten protein by enzymes to make aqueous colloidal dispersion substantially increases the cost of fabrication besides an addition of sophisticated processing step necessary to handle delicate enzymes. Likewise, in the method of making aqueous colloidal dispersion of gluten micro-particles; see prior art [Cook et. al., U.S. Pat. No. 5,705,207, Jan. 6, 1998], starch is first gelatinize and then hydrolyze with enzymes. The gelatinized starch weaken the film structure and produce non-transparent films; see prior art [Bassi et. al., U.S. Pat. No. 5,977,312, Nov. 2, 1999].

Hence, there is a valid and justified reason to improve the method of fabrication of gluten derived edible films and coatings having superior sensory, physical and barrier properties while avoiding use of large quantities of ethanol, enzymes and disruptive or reducing agents in order to make it cost effective.

### THE PRESENT INVENTION

In order to meet the above mentioned requirements, a method of fractionation has been revealed by the present inventors. The novelty of the present invention is based on the fact that the gluten derived edible film is fabricated neither by casting of ethanolic extract of the gluten nor by modifying gluten with costly enzymes or reducing agents. Innovatively, the present inventors fractioned the ethanolic extract of the gluten under controlled conditions to obtain a high protein fraction, primarily gliadin protein. This fractionated portion is then homogenized with a plasticizer before casting or coating on to the food products.

The aim of fractionation is to collect the gluten derived protein fraction having desirable film making properties. Moreover, fractionation removes unwanted color forming impurities leading to formation of clear and transparent fraction rich in gliadin protein. The edible films and coatings produced by the present method are cost effective as more than 80% of the ethanol is recoverable. The cost of fractionation is minimal as it has been performed at low temperature simply attainable by domestic refrigeration system. Similarly, instead of using costly enzymes and heat energy for gelatinization, starch is simply removed by washing and subsequently recovered as a by-product which may find its applications in gluten-free products thus augmenting the commercial viability of the present invention.

Most of the films revealed by prior work exhibited excellent edible and barrier properties but fail to achieve good heat sealing together with solubility. Productively, the solubility of edible film presented herein is such that it can be removed conveniently by simple washing or it can release the packaged contents in hot water when used for packaging ready-to-eat foods. Furthermore, the edible film presented herein is heat sealable and exhibited excellent mechanical properties so that the package may not be torn to release its content during packaging and handling. Similarly, if such film is applied on fresh horticulture produces, they not only extend the shelf-life by virtue of excellent barrier properties but also give choice and statutory right to consumer to eat edible film as such or removed simply by washing. In view of allergens in foods, particularly celiac disease, the solubility of edible film presented herein is more important for the peoples who are gluten-intolerant.

Unlike some commercial preparations of gluten derived edible films and coatings, the edible films presented here neither impart any objectionable flavor nor any color or odor. Last but not the least, the method described herein does not require any pH adjustments; hence broaden the compatibility of the edible films and coatings with any type of food product.

### SUMMARY OF THE INVENTION

A fraction of gliadin is fractioned from ethanolic extract of gluten by virtue of difference in solubility mediated by temperature. This gliadin fraction is the then later utilized along with a plasticizer to fabricate free standing edible film.

The films produced by above method are clear and transparent. Being derived from naturally-occurring source i.e. gluten, the film is non-toxic and cause no harm to human health if eaten along with the food product. After casting or coating, the films described herein have excellent resistance to moisture, lipid and gas permeation. According to packaging perspective, they also have good mechanical properties together with glossy sheen compared to other water soluble proteins used as edible films and coatings.

### BRIEF DESCRIPTION OF THE DRAWING

The single drawing is a schematic flow diagram illustrating the method via sequential steps for obtaining gluten derived edible films and coatings involving fractionation.

### DETAILED DESCRIPTION OF THE INVENTION WITH REFERENCE TO ACCOMPANYING DRAWING

This invention discloses a method of recovering fraction of gliadin from ethanolic extract of wheat gluten proteins by the process of fractionation. This was accomplished by altering the solubility of ethanolic extract of gluten under controlled conditions. The fraction of gliadin is then utilized to make heat-sealable, water soluble, homogenous and transparent films with novel functional and mechanical properties. The resultant fraction, being stable and homogenous, can be stored safely under ambient storage conditions without spoilage or microbial contamination. Films are produced by casting technique followed by drying.

Turning to the drawing, preferred steps in accordance with the invention are schematically set forth with particular reference to the use of wheat gluten as the starting material to fabricate edible films and coatings. Gluten and gluten-derived proteins were found useful in the method of this invention as they are found in high concentrations in various grains, such as corn, wheat, barley, rice, sorghum and in other plant proteins. Natural wheat gluten from indigenous wheat cultivars is particularly preferred in the method of this invention.

Referring to step 1 of the drawing, a preferred process of the invention begins by mixing measured quantity of wheat flour with water in a mixer preferably installed with an agitator to facilitate maximum gluten development. Gluten is produced from gliadin and glutenin in wheat flour by the process of hydration and mixing.

In one embodiment, dough having satisfactory gluten network is developed by mixing 200 ml of water with 300 gm of wheat flour. Furthermore, mixers installed with hook agitator and intermittent addition of water during mixing is found effective in the formation of stiff dough with better development of gluten network. In the illustrated process, the flour obtained from wheat cultivars has an average test weight of 77 kg/hl with an average hardness score of 54. In order to be the most suitable starting material, the wheat flour should have a moisture content of 10.4% with an average wet gluten content of 33%.

Referring to step 2 of the drawing, the dough is immersed in a stream of running water to wash away starch and other soluble components leaving a cohesive and elastic mass of gluten. Dough is a highly complex system primarily made up of starch and proteins. Gluten protein play a very important role in this structure as it forms a continuous three-dimensional network in which starch granules are embedded.

Gluten is a complex mixture of proteins containing several hundred polypeptides, about half of the protein is monomeric, gliadin, and the remainder is disulfide-cross linked polypeptides that forms the polymeric glutenin fraction; see [Gianibelli, M. C., Larroque, O. R., MacRitchie, F., and Wrigley, C. W., 2001. Biochmical, Genetic and Molecular Characterization of Wheat Glutenin and Its Component Subunits, Cereal Chem., 78 (6), 635-646]. In a way, gluten development by dough formation is a purification step for wheat proteins thereby providing an opportunity to agglomerate in to water insoluble cohesive mass which is easily recoverable by washing. Starch is collected separately as a by product which is then later dried, sieved and packed for use in gluten-free products.

Despite its insolubility and hydrophobic nature, gluten absorbs approximately twice its dry weight of water to form a hydrated visco-elastic mass; see [Day, L., Augustin, M. A., Batey, I. L., and Wrigley, C. W., 2006. Wheat-Gluten Uses and Industry Needs, Trends In Food Science and Technology, 17: 82-90]. Referring to step 3 of the drawing, wet gluten is partially dried to moisture content preferably in the range of 30 to 35%. To avoided unnecessary protein denaturation, drying is performed at ambient conditions via forced circulation of the air to convect away excess moisture from the wet gluten. If the moisture attached herewith wet gluten is not reduced to the desired level then it will hamper the formation of free standing edible films.

Referring to step 4 & 5 of the drawing, the air dried gluten is brought in to contact with absolute ethanol for a predetermined period to leach out gliadin protein. Gliadin makes up the prolamine fraction of wheat endosperm. They are low molecular weight proteins in the wheat gluten complex known for their solubility in 70% ethanol; see [Gennadious, A., McHugh, T. H., Weller, C. L., & Krochta, J. M., 1994 b. Edible Coating and Films based on Proteins. Ch. 9 in ‘Edible Coating and Films to Improve Food Quality’ (M. Krochta, E. A. Baldwin and M. Nisperos-Carrieddo, eds), 201-277. Technomic Publishing Co., Inc., Lancaster, Basel].

It is possible to achieve high protein concentration, though to a limited extent, by increasing ethanol temperature during extraction. In one of the embodiment, extraction is performed by extractor having jacketed vessel such that hot oil is circulated via jacketed vessel to increase the temperature of ethanol during extraction. Similarly, forced circulation of ethanol by suitable agitator also assists optimized recovery of gliadin protein. After extraction, mechanical filtration is necessary for the removal of protein insoluble in ethanol.

Step 6 as illustrated in the drawing involves concentration of the filtrate to increase the protein content in the film forming dispersion prior to casting. This step is performed in a rotary evaporator preferably under vacuum to avoid unnecessary heat induced degradation in the protein structure. Density and viscosity are the tools employed to monitor the degree of concentration of the film forming dispersion. The ethanol vapors given off during concentration are subsequently recovered by condensation to avoid any possible health hazard. This will also assist to cut down fabrication cost of gluten derived edible films and coatings.

Referring to the drawing, step 7 involves a process that uses negative heat to separate a substance in to its components i.e. fractionation of concentrated protein fraction. Based on electrophoretic mobility, gliadin is comprised of four groups i.e. α, β, γ and ω gliadin. The molecular weight of these groups range from 30,000-40,000 for α, β and γ gliadin while 60,000-80,000 for ω gliadin; see [Gennadious, A., McHugh, T. H., Weller, C. L., & Krochta, J. M., 1994 b. Edible Coating and Films based on Proteins. Ch. 9 in ‘Edible Coating and Films to Improve Food Quality’ (M. Krochta, E. A. Baldwin and M. Nisperos-Carrieddo, eds), 201-277. Technomic Publishing Co., Inc., Lancaster Basel]. As a result of fractionation at low temperature, the high molecular weight fraction is settled down as sediment leaving a greater concentration of low molecular weight fraction in the supernatant. Color forming impurities are also settled down along with the sediment.

The properties of gluten derived edible films and coatings can be tailored for a given application by modifying ethanol dispersion. Generally, additives are incorporated in the ethanol dispersion for this purpose in order to improve barrier, physical and mechanical properties. Examples of suitable additives include waxes, e.g., bee, paraffin, candelilla, rice bran, japan, ceresin, microcrystalline, sugar cane, petroleum and carnauba wax; oils and/or surfactants, e.g., acetylated glycerides, or diacetyl tartaric acid esters of mono- and di-glyecrides (DATEM esters) to improve the water resistance while glycerol, polypropylene glycerol or polyethylene glycols can be used to plasticize films. Addition of colors, flavors, antioxidants and preservatives can also improve and broaden the functionality of the films such as to extend shelf-life, reduce or prevent microbial growth and the like.

Additives which are soluble in water can be incorporated in the coating formulation by the direct dissolution in the ethanol dispersion. Additives which are insoluble in water may dispersed by surfactants and added as an emulsion. Examples of insoluble additives but are not limited to oils, flavors, trace minerals, vitamins, nutrients or nutraceuticals; see prior art [Shulman et. al., U.S. Pat. No. 6,174,559, Jan. 16, 2001].

Like other proteins films, gluten derived ethanol dispersion also form brittle films due to extensive interactions between protein chains through hydrogen bonding, electrostatic forces, hydrophobic bonding and disulphide cross linking; see [Geenadios, A., 2002. Protein-based Films and Coatings, ed. A. Gennadios, CRC Press LLC, USA]. Referring to step 8 of the drawing, a plasticizer, glycerin, is added to reduce film brittleness and ensure the formation of free-standing films. Plasticizers are hydrophilic low molecular weight liquids that reduce protein chain-to-chain interaction. Gluten protein plasticization is a complex phenomenon that can be primarily explained by the ability of the hydrophilic plasticizer molecule to share hydrogen bonds with protein network. The result is an increase in free volume and the mobility of the polymer chains, lower glass transition temperature and more flexible and soft films; see [Mangavel, C., et al., 2003. Molecular Determinants of the Influence of Hydrophilic Plasticizers on the Mechanical Properties of Cast Wheat Gluten Films, Journal of Agriculture and Food Chemistry, 51(5): 1447-1452].

Step 9 illustrated in the drawing involves the mixing of plasticizer in the gluten derived ethanol dispersion by the homogenizer. This step not only ensures the uniform and even distribution of plasticizer but also switch the viscosity of the film forming dispersion favorable for casting. In one of the embodiment, gluten derived edible film is fabricated with out homogenization of the plasticizer. The resultant film produced showed much more variance in the mechanical properties, tensile strength, as the edible film containing greater proportion of plasticizer exhibited a soft rubbery texture while the film with a lesser proportion of plasticizer showed brittle and short texture.

The second last stage of fabricating gluten derived edible films is illustrated in step 10 of referred drawing. Casting is a simple yet useful technique that allows film thickness to be controlled accurately on flat and smooth surfaces. Casting can be accomplished either by pouring measured volume of the film forming dispersion or by controlled-thickness spreading. The later method requires a spreader with a product reservoir attached herewith an adjustable valve for controlled flow. The spreader is simply drawn over the receiving surface, depositing a layer of film forming solution of the desired thickness followed by drying; see [Donhowe, I. G., and Fennema, O., 1994 b. Edible Films and Coatings: Characteristics, Formation, Definitions, and Testing Methods. Ch. 1 in ‘Edible Coating and Films to Improve Food Quality’ (M. Krochta, E. A. Baldwin and M. Nisperos-Carrieddo, eds), 201-277, Technomic Publishing Co., Inc., Lancaster Basel]. With reference to preferred method, casting is performed by pouring gluten derived ethanol dispersion. In addition to volume, the thickness of the dried film is primarily controlled by density of the film forming dispersion which in turn reflects protein concentration.

Drying or curing of the gluten derived ethanol dispersion is the last step as mentioned in the referred diagram. Drying conditions can affect protein conformation and improves some film forming properties depending on heating conditions. Rising the drying temperature can denature globular proteins leading to the lost of native conformation of gliadin proteins and they open. It will expose the previously unexposed intramolecular disulphide bonds which can now be reduced and form other new intermolecular disulphide bonds. As drying proceeds, solvent removal increases the concentration of gluten proteins so that active sites for bond formation becomes free and close enough to each other to crate new interactions. New hydrogen bonds, hydrophobic interactions and disulphide bonds contribute to formation of a good oxygen barrier three-dimensional network; see [Kayserilioglu, B. S., et al., 2003. Mechanical and Biochemical Characterization of Wheat Gluten Films as a Function of pH and Co-solvent. Starch/Stärke, 53: 381-386; Gennadious, A., and Weller, C. L., 1990. Edible Films and Coatings from Wheat and Corn Proteins. Food Technol. 44(10), 63-69; Gennadios, A. 2002. Protein-based Films and Coating, Ed. A. Gennadios. CRC Press LLC, USA & Guilbert, S. 2002. Formation and Properties of Wheat Gluten Films and Coatings, in Protein based Films and Coatings, A. Gennadios, Editor].

In terms of industrial applications, the gluten derived ethanol dispersion can be used in various applications in the food and pharmaceutical industries. Suitable substrate include but are not limited to confections; raw, cooked and dehydrated meat; desserts; snack foods; chocolates; bubble and chewing gums; fruits and vegetables; baked goods; seed, nuts and beans; vitamins; tablets; cheese and fried foods. The film can be applied to foods to form an edible barrier to moisture, lipid and gases or to incorporate additives such as color, flavor, antioxidants and/or preservatives. Similarly, the film is equally applicable to heterogeneous food systems where it is desirable to prevent migration of components such as keeping moisture from escaping or migrating with in the system, or preventing colors and/or flavors from blending. In terms of drug applications, the gluten derived edible films and coatings can be applied to tablets for oral ingestion and enteric coatings, for example, to provide a moisture barrier between the drug and the air; see prior art [Cook et. al., U.S. Pat. No. 570,207, Jan. 6, 1998].

Similarly, numbers of methods are employed for the application of edible coatings on the substrate. Spraying, brushing, dipping, pouring, rolling, extrusion and co-precipitation are the examples to quote in this context. Depending upon the particular method employed, some times it may be necessary to adjust the viscosity of film forming dispersion which is primarily controlled by temperature and the concentration of the plasticizer. For example, plasticizer is generally added to the ethanol dispersion to facilitate drying, particularly at ambient temperature and to augment gloss.

The properties of gluten derived edible films and coatings can be modified by controlling the concentration of protein in the ethanol dispersion, the mode of application and the number of layers applied.

### EXAMPLE

Non-infested samples of wheat were obtained from Wheat Research Station, Sakrand, Pakistan. Each sample was mixed thoroughly by precision electronic divider (Seedburo Equipment Company, Model No. SB-106) and cleaned manually. Test weight was determined using a standard One-Liter Bucket procedure (Dexter & Tippler, 1987). Grains of each wheat variety were then milled through Perten Laboratory Mill 3100 installed with 0.8 mm sieve.

Wheat flour (1000 gm) was taken in a planetary mixer installed with hook agitator (Kenwood KM-400, U.K.) and mixed vigorously to form soft dough by adding distilled water. The water-soluble components were then leached out by repeated washing until washed water became transparent and showed negative Iodine-Starch test. The gluten was then dried in air circulating oven maintained at 40° C. for 3 hours. Dried gluten was mixed and stirred with absolute ethanol in a blender (Panasonic MJ-W176P, Japan) followed by filtration. The filtrate is then concentrated under vacuum in a rotary evaporator (BÜCHI Rotavapor R-200, Switzerland) operated at a temperature of 40° C. Film concentration was controlled and adjusted by density (0.982-1.004 gm/ml) and refractive index (1.4267-1.3515, Abbe Digital Refractometer, ATAGO DR-A1, Japan). After the addition of plasticizer, glycerol 0.63% w/w, film solutions were then homogenized to dispersing aggregates Ø 12 mm at 11000 rpm for 10 minutes (Polytron Kinematica PT-MR 2100, Littau-Lucerne, Switzerland). Film forming solutions were cast on to the square shaped non-stick flat glass plates. Film thickness was primarily controlled by volume of the film concentrate. Films were placed and allowed to dry in air-circulating oven running at 40° C. at ambient relative humidity. Glass plates were also balanced by bubble balancer (Stabila, Germany) for uniform film thickness. After drying for 24 hours, films were peeled off for thermal and mechanical study.

We claim:

1. A method for producing edible or biodegradable film comprising a matrix of gliadin protein, water and plasticizer, involving:
a. recovery of gluten as a cohesive and elastic mass left after starch is washed away from wheat flour dough;
b. air drying of the product of step (a) at a temperature of 30-35° C. with relative humidity 40-50%;
c. leaching gliadin by contacting product of step (b) with absolute ethanol under agitation condition followed by filtration;
d. concentrating the product of step (c) in a rotary evaporator under vacuum;
e. fractionating gliadin protein by storing the product of step (d) at low temperature to settle down gel like material leaving a thin transparent supernatant;
f. adding plasticizer to the supernatant of step (e) followed by homogenization;
g. casting or coating the product of step (f) on an inert surface or a substrate which upon drying results transparent free standing film and imparts a gloss thereon.

2. The method of claim 1, where in the gluten is from wheat, corn, barley, rice, rye or sorghum.

3. The method of claim 1, where in step (a) is performed by water.

4. The method of claim 1, where in gluten in step (b) is air dried to moisture content of 32%.

5. The method of claim 1, where in for leaching in step (c), the proportion of ethanol and dried gluten is 10:1.

6. The method of claim 1, where in the gliadin extract in step (d) is concentrated to 0.978-1.004 gm/ml.

7. The method of claim 1, where in the fractionation in step (e) is performed at 10° C. for 12 hours.

8. The method of claim 1, where in protein concentration after fractionation and before adding plasticizer is 2.4-2.8%.

9. The method of claim 1, further comprising incorporating an additive which is selected from the group consisting of plasticizers, coloring agent, flavoring agent, trace minerals, vitamins, nutrients, nutraceuticals and combinations thereof.

10. The method of claim 1, said plasticizer in step (f) is being selected from the group consisting of glycerol, diglycerol, propylene glycol, triethylene glycol, sorbitol, mannitol, maltitol, poly vinyl alcohol, polyethylene glycol and mixtures thereof.

11. The method of claim 1, said plasticizer in step (f) is glycerol.

12. The method of claim 1, said plasticizer in step (f) is present at a level of 0.4-1.2%.

13. The method of claim 1, further comprising adding a preservative to the final product.

14. The method of claim 1, where in homogenization in step (f) is carried out to dispersing aggregates \acute{Ø} 12 mm at 11000 rpm.

15. The method of claim 1, where in casting in step (g) is performed by filling gliadin protein concentrate in a rectangle shape inert container having at least 25 mm depth.

16. The method of claim 1, where in drying in step (g) is carried out in an air-circulating oven maintained at 45° C. with 40-45% R.H for 1 to 2 hours.

17. The method of claim 1, said film after drying has gliadin protein at a level of 45-49% by weight.

18. The method of claim 1, said film is 0.25 mm thick.

19. The method of claim 1, said film after drying has a moisture content of 8.22-10.3% by weight.

20. The method of claim 1, said film is soluble in water.

21. The method of claim 1, said film has a tensile strength in the range of 0.13-1.3 N/mm².

22. The method of claim 1, said film has a breaking strength in the range of 0.03-0.32 N/mm².

23. The method of claim 1, said film has a puncture strength in the range of 0.16-0.23 N/mm².

24. The method of claim 1, said film has penetration strength in the range of 0.06-0.53 N/mm².

25. The method of claim 1, where in substrate for coating in step (g) is selected from the group consisting of chocolates, high sugar confections, fruits, meats, baked goods, vegetables, seeds, nuts, beans, cereals, vitamins, tablets, cheese, fried foods, French fries and snack foods.

26. The method of claim 1, where in substrate having an edible coating thereon, the ethanol dispersion was removed at 25-35° C. with swift air circulating motion.
